(19) United States
(12) Patent Application Publication
(10) Pub. No.: US 2009/0201683 A1
(43) Pub. Date: Aug. 13, 2009

(54) LIGHT-EMITTING DIODE (LED) LAMP WITH A COOLING SEAT

(76) Inventor: Tang Shih Chuan, Tucheng City (TW)

Correspondence Address: EGBERT LAW OFFICES, 412 MAIN STREET, 7TH FLOOR, HOUSTON, TX, 77002, US

(21) Appl. No.: 12/028,559

(22) Filed: Feb. 8, 2008

(51) Int. Cl. F21V 29/00

(52) U.S. Cl. 362/294

(57) ABSTRACT

The light-emitting diode (LED) lamp of the present invention has a main body with an inner space provided with an open end and inner wall. The LED baseplate is mounted into the inner space. The inner wall is provided with a reducing through-hole, and front and rear stop edges are formed on the wall. The back side of the LED baseplate is sustained by the front stop edge. An insertion portion for plugging into the reducing through-hole is provided with one end of the cooling seat. The end surface of the cooling seat is sustained by the back side of the LED baseplate, and a retaining edge is arranged around the other end of the cooling seat for positioning at the rear stop edge. The LED baseplate and cooling seat are positioned through a locator.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a light-emitting diode (LED) lamp, and more particularly to an innovative lamp with a combined cooling seat structure.

2. Description of Related Art Including Information Disclosed Under 37 CFR 1.97 and 37 CFR 1.98.

To reduce overheating during operation of an LED lamp, a cooling seat structure is incorporated into existing LED lamps for elimination of heat.

The addition of the cooling seat will lead to increases in assembly time and costs. A key technology issue is how to realize the combination and positioning of the cooling seat with the most simple structure.

As for a combined cooling seat of a typical LED lamp, the LED baseplate is first assembled onto the heating surface of the cooling seat. Then, the cooling seat is positioned onto the preset location of LED lamp body, but these two procedures will bring about time-consuming and expensive assembly, making it necessary to make improvements.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

The cooling seat of an LED lamp of the present invention is assembled through a single locator, in combination with the front and rear stop edges on the inner wall of the main body for limitation of the LED baseplate and cooling seat. The cooling seat and main body of the LED lamp is assembled with the LED baseplate more simply and quickly through a single locator, thereby reducing the assembly cost and improving the economic efficiency with a better heat transfer effect.

There are improvements brought about by this invention.

Based on the structure of the soft pad being arranged between the retaining edge of the cooling seat and the rear stop edge of the main body, the cooling seat and LED baseplate are coupled more firmly and securely.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the preferred embodiment of the present invention.

FIG. 2 shows an exploded perspective view of the preferred embodiment of the present invention.

FIG. 3 shows an exploded sectional view of the preferred embodiment of the present invention.

FIG. 4 shows an assembled sectional view of the preferred embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

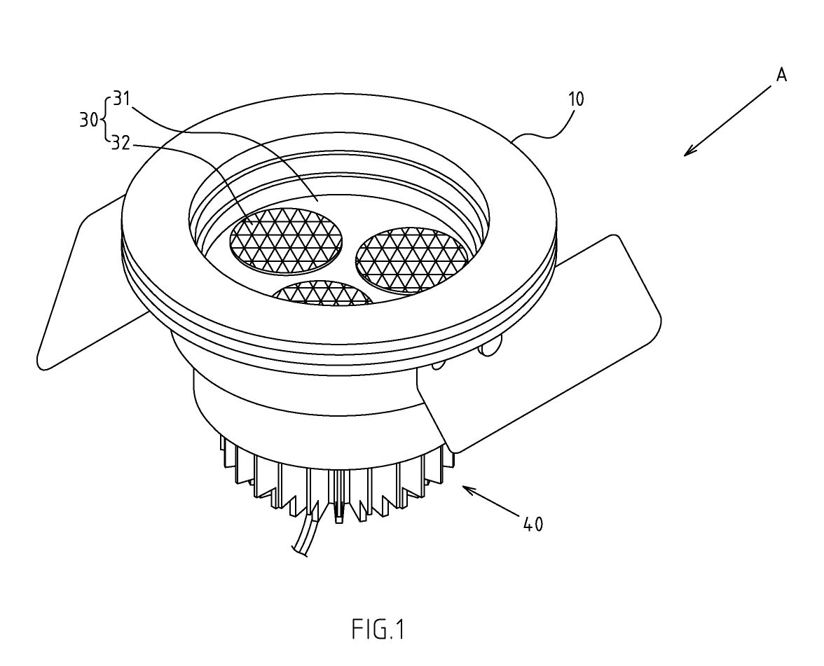

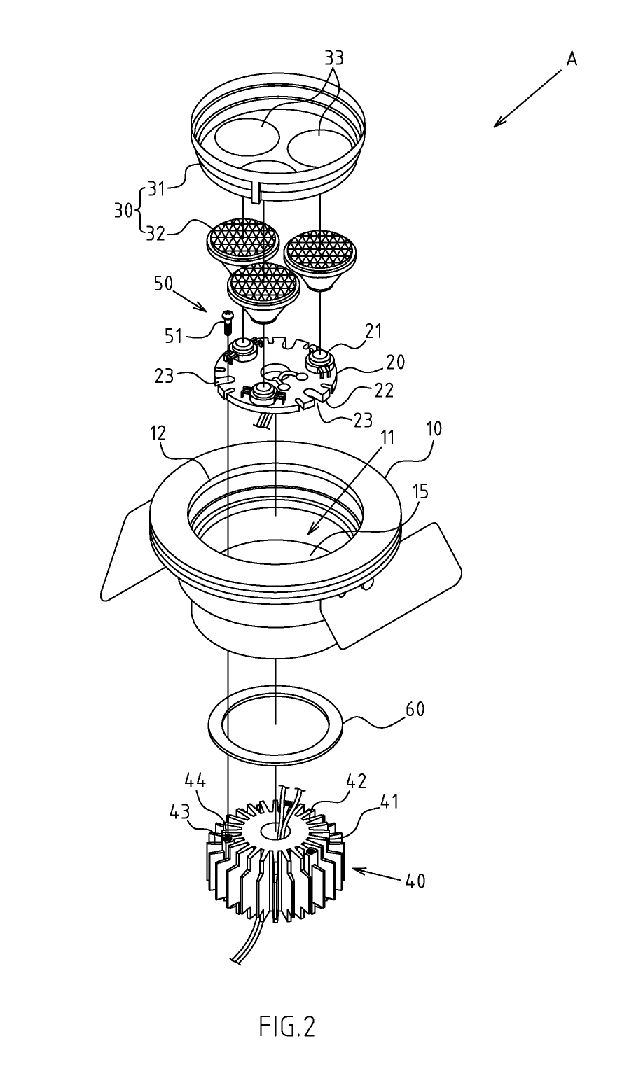

FIGS. 1-4 depict preferred embodiments of a combined cooling seat of an LED lamp of the present invention. The embodiments are provided only for explanatory purposes with respect to the patent claims.

The LED lamp A comprises a main body 10, a LED baseplate 20, a light projector 30, and a cooling seat 40. The main body 10 is provided with an inner space 11, which forms an open end 12 and an inner wall 13. The LED baseplate 20 is mounted into the inner space 11, and some LEDs 21 are placed in front of the LED baseplate 20. The light projector 30 is assembled in the open end 12 of the inner space 11.

The inner wall 13 is provided with a reducing through-hole 14, while a front stop edge 15 and a rear stop edge 16 are formed on the wall of the reducing through-hole 14.

The back side 22 of LED baseplate 20 is sustained by the front stop edge 15.

One end of the cooling seat 40 is provided with an insertion portion 41 for plugging into the reducing through-hole 14 on the inner wall 13 of the inner space 11. One end surface 42 of the cooling seat 40 is sustained by the back side 22 of LED baseplate 20. Moreover, a retaining edge 43 is arranged around the other end of the cooling seat 40 for positioning at the rear stop edge 16.

The LED baseplate 20 and cooling seat 40 are positioned through a locator 50. As shown in the preferred embodiment, the locator 50 is made of a plurality of bolts 51, such that LED baseplate 20 and cooling seat 40 are separately provided with punch hole 23 and screw hole 44. The bolts 51 could be screwed into the screw hole 44 after passing the punch hole 23, thus enabling the positioning of LED baseplate 20 and cooling seat 40.

The light projector 30 comprises a light shield 31 and several refraction blocks 32. The light shield 31 is provided with several through-holes 33 for sleeving of the refraction block 32.

A soft pad 60 is arranged between the retaining edge 43 of cooling seat 40 and the rear stop edge 16 of the main body 10. The soft pad 60 is made of rubber or silica gel, which allows the cooling seat 40 and LED baseplate 20 to be coupled more firmly and securely.

Based upon above-specified structures, the present invention is operated as follows:

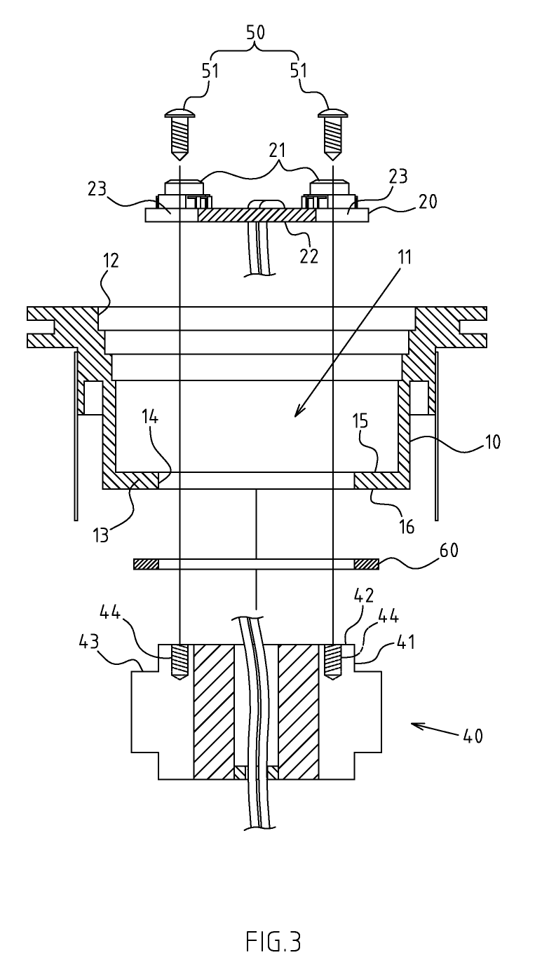

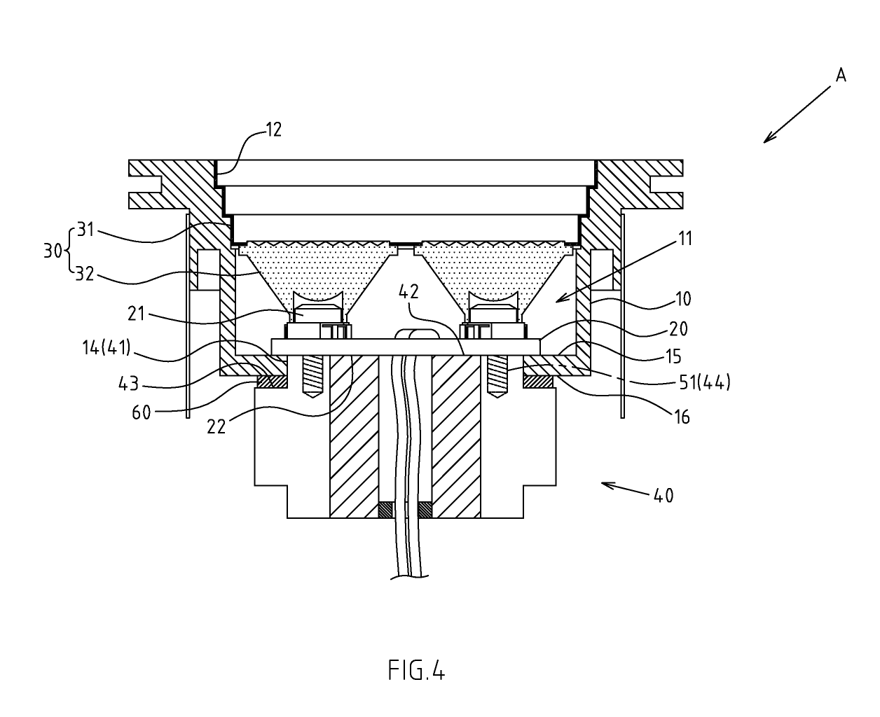

The LED lamp A of the present invention allows the cooling seat 40 to be integrated and assembled in a more simple way. Referring to FIGS. 3 and 4, when the cooling seat 40, the main body 10 and LED baseplate 20 are to be assembled together, the LED baseplate 20 is inserted into the inner space 11. The back side 22 is sustained by the front stop edge 15 of the reducing through-hole 14. On the other hand, one end of the main body 10 with inner wall 13 is adapted to the main body 10. Then, the insertion portion 41 of the cooling seat 40 is inserted into the reducing through-hole 14 of the inner wall 13. Meanwhile, the end surface 42 of the cooling seat 40 is sustained by the back side 22 of the LED baseplate 20, and the retaining edge 43 of the cooling seat 40 is sustained by the rear stop edge 16 formed on the wall of the reducing through-hole 14. Next, the bolts 51 of the locator 50 could be screwed into the screw hole 44 after passing the punch hole 23 of LED baseplate 20, thus enabling the positioning of LED baseplate 20, cooling seat 40 and main body 10.

The LED lamp A of the present invention is assembled through a single locator 50, in combination with the front and rear stop edges 15, 16 on the inner wall 13 of the main body 10 which are used for limitation of the LED baseplate 20 and cooling seat 40. Thus, the cooling seat 40 and main body 10 can be positioned quickly. Moreover, the end surface 42 of the cooling seat 40 could be directly sustained by the back side 22 of the LED baseplate 20, thus permitting fast heat radiation with better heat transfer and elimination effect.

1. A light-emitting diode (LED) lamp, comprising:
a main body, having an inner space forming an open end and an inner wall;
a reducing through-hole, being open on said inner wall of said inner space and having a wall with front and rear stop edges formed on said wall;
an LED baseplate, being assembled in said inner space of said main body and having a back side sustained by the front stop edge;
a cooling seat, having one end provided with an insertion portion plugged into said reducing through-hole, and an end surface sustained by said back side of said LED baseplate;
a retaining edge arranged around the other end of said cooling seat, positioning at the rear stop edge;
a light projector, being assembled onto said open end of said inner space of said main body; and
a locator, being assembled on said LED baseplate in alignment with said cooling seat, enabling positioning of said LED baseplate and said cooling seat.

2. The LED lamp defined in claim 1, wherein said light projector comprises a light shield and several refraction blocks, said light shield being provided with several through-holes sleeving of said refraction block.

3. The LED lamp defined in claim 1, further comprising:
a soft pad is arranged between said retaining edge and the rear stop edge of said main body.

4. The LED lamp defined in claim 1, wherein said locator is comprised of bolts, said LED baseplate and said cooling seat being separately provided with a punch hole and a screw hole, the bolts being screwed into said screw hole after passing said punch hole, said LED baseplate and said cooling seat being positioned by the bolts.
